(19) United States
(12) Patent Application Publication
(10) Pub. No.: US 2009/0034836 A1
(43) Pub. Date: Feb. 5, 2009

(54) Image Processing Apparatus, Image Processing Method, and Computer Readable Recording Medium Stored with Image Processing Program

(75) Inventor: Toshimi Shinchi, Saitama-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 12/108,982

(22) Filed: Apr. 24, 2008

(30) Foreign Application Priority Data
Aug. 1, 2007 (JP) 2007-200814

(51) Int. Cl. G06K 9/00

(52) U.S. Cl. 382/167

(57) ABSTRACT

The image processing apparatus displays an image based on image data and identifies a focal position designated by a user within the displayed image. Next, the image processing apparatus creates patch image data equipped with patches indicating a plurality of candidates of output density after density adjustment using a tone curve based on the image data at the focal position. The image processing apparatus then outputs the image data and the patch image data.

### CROSS-REFERENCE TO RELATED APPLICATION

This application is based on Japanese Patent Application No. 2007-200814 filed on Aug. 1, 2007, the contents of which are incorporated herein by reference.

### BACKGROUND

1. Technical Field

The present invention relates to an image processing apparatus, an image processing method, and a computer readable recording medium stored with an image processing program. In particular, the present invention relates to an image processing apparatus having a tone curve correcting function, an image processing method, and a computer readable recording medium stored with an image processing program.

2. Description of Related Art

A tone curve that represents the output density relative to the input density is used in correcting the gradation of an image. In correcting the gradation of an image, a user modifies the tone curve and prints out the image to check it out while grasping how much a modification amount on the tone curve is reflected upon the printed material. The user then further modifies the tone curve depending on the result of the confirmation printing and repeats the check out printing. Therefore, the user used to require multiple confirmation printings until a printed material with a desirable density is obtained.

In order to solve such a problem, a printer has been proposed which prepares a standard sample image that is obtained by reducing the size of an image to be outputted or designating a part of area in the image and prints out a synthesized image that shows an array of many sample images which are created by changing an adjustment amount such as density of the standard sample image in stages. See Unexamined Japanese Patent Publication No. 9-52355. According to such a technology, the user can set up the adjustment data such as density conveniently by entering the identification number attached to a desired sample image.

However, the user has to select the sample images for the entire image or for a designated area in case of said Unexamined Japanese Patent Publication, so that said technology does not allow the user to designate a specific location on the image for adjusting the density. Consequently, there remained a problem that it does not allow the user to obtain a printed material precisely reflecting the user's preference. Moreover, there is also a problem that it is necessary to apply additional image processes such as a rasterization process to the entire image or to a designated area in creating a sample image so that it tales a longer time for the process of printing out a sample image.

### SUMMARY

To solve at least one of the abovementioned problems, an image processing apparatus reflecting one aspect of the present invention is provided. The image processing apparatus comprises: a display unit for displaying an image based on image data; an identifying unit for identifying a focal position designated by a user with in said image displayed on said display unit; a creating unit for creating patch image data equipped with patches indicating a plurality of candidates of output density after density adjustment using a tone curve based on said image data at said focal position; and an outputting unit for outputting said image data and said patch image data.

It is preferable that said outputting unit further outputs information that indicates said focal position within said image.

It is preferable that said creating unit creates patch image data in accordance with the density range of all the patches and the density interval between the patches designated by the user, using the output density based on said image data at said focal position as the standard.

It is preferable that said patch image data contains information that indicates the density value of each patch.

It is preferable that said outputting unit outputs said patch image data to an identical page to which said image data belongs.

It is preferable that said patch image data is outputted to a location within the page which is designated by the user. It is preferable that said outputting unit prints out said image data and said patch image data with the halftone dots designated by the user.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the overall constitution of a network system according to a first embodiment of the present invention.

FIG. 2 is a block diagram showing the constitution of the PC shown in FIG. 1.

FIG. 3 is a block diagram showing the constitution of the printer controller of the printing system shown in FIG. 1.

FIG. 4 is a block diagram showing the constitution of the printer of the printing system shown in FIG. 1.

FIG. 5 is a schematic diagram showing the constitution of a printing unit.

FIG. 6 is a flow chart showing the process procedure on the PC.

FIG. 7 is a diagram showing an example of a GUI screen.

FIG. 8 is a flow chart showing the process sequence on the printer controller.

FIG. 9 is a flow chart showing the sequence of creating a patch image.

FIG. 10 is a schematic diagram for describing the creation and output of a patch image.

FIG. 11 is a diagram showing another example of printed outputs.

FIG. 12 is a diagram showing still another example of printed outputs.

FIG. 13 is a diagram showing an example of codes used to create a patch image.

FIG. 14 is a diagram for describing input boxes for the input densities and the output densities of the focal positions in order to reflect them on the tone curve.

FIG. 15 is an example of the GUI screen according to a second embodiment.

FIG. 16 is a schematic diagram for describing the creation and output of the patch image according to the second embodiment.

FIG. 17 is a flowchart showing the process of tone curve correction on a PC according to the second embodiment.

FIG. 18 is a diagram for describing the method of correcting a tone curve using the chart image and the patch image which are displayed.

FIG. 19 is an enlarged diagram of the scan image data for describing the process of designating the focal position and the patch position

FIG. 20 is a schematic diagram for describing the creation of the patch image concerning a third embodiment.

### DETAILED DESCRIPTION

The preferred embodiments of the invention will be described in detail below with reference to the accompanying drawings.

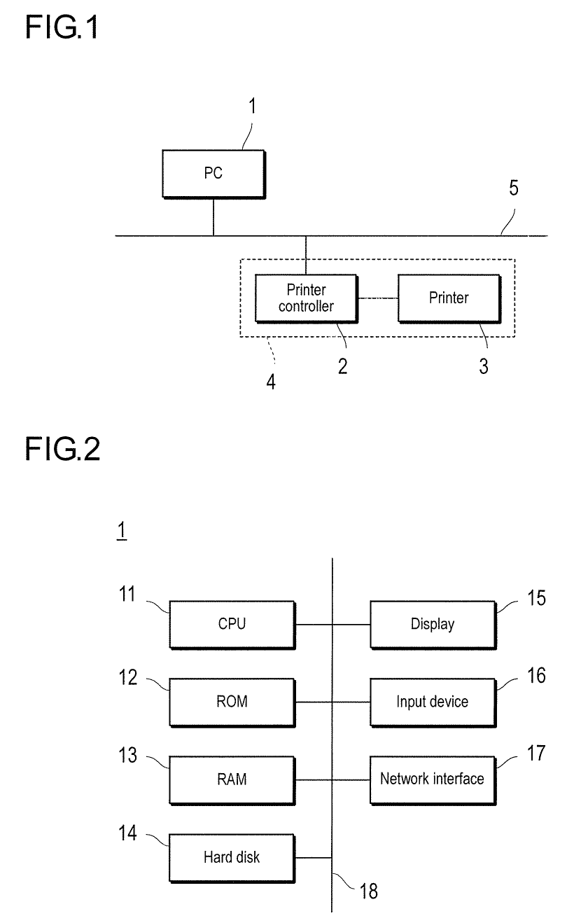

FIG. 1 is a block diagram showing the overall constitution of a network system according to a first embodiment of the present invention.

The network system that relates to this embodiment is equipped with a PC 1 as a printing instruction device for instructing the printing of the document and a printing system 4 for conducting printing based on the printing instruction of the PC 1, which are communicably connected with each other via a network 5. The PC 1 and the printing system 4 can be connected directly (local connection) without recourse to the network 5.

The printing system 4 consists of a printer controller 2 and a printer 3 as an image forming apparatus, which are locally connected with each other. This local connection can be accomplished by means of various local connection interfaces, such as serial interfaces, e.g., USB and IEEE 1394, parallel interfaces, e.g., SCSI and IEEE 1284, wireless communication interfaces, e.g., Bluetooth®, IEEE 802.11, HomeRF®, IrDA®, etc. However, the printer controller 2 and the printer 3 can be connected via the network 5.

FIG. 2 is a block diagram showing the constitution of PC 1 shown in FIG. 1.

The PC 1 contains a CPU 11, a ROM 12, a RMA 13, a hard disk 14, a display 15, an input device 16 and a network interface 17, all of which are interconnected via a bus 18 for exchanging signals.

The CPU 11 controls various parts indicated above and executes various arithmetic processes according to a program. The ROM 12 stores various programs and data. The RAM 13 stores programs and data temporarily as a working area. The hard disk 14 stores various programs including an operating system and data.

Installed on the hard disk 14 are: a document creating application program for creating document files; a printer driver for converting document files into PDL data described in Page Description Language (PDL) that the printer controller 2 can understand; and a gradation correction application program.

The display 15 can be LCD, CRT, and other displays, on which various kinds of information are displayed. The input device 16 includes a pointing device such as a mouse, a keyboard, and others, and is used for executing various kinds of information inputs.

The network interface 17 is an interface for communicating with other devices on the network via the network 5 using standards such as Ethernet®, Token Ring, FDDI, etc.

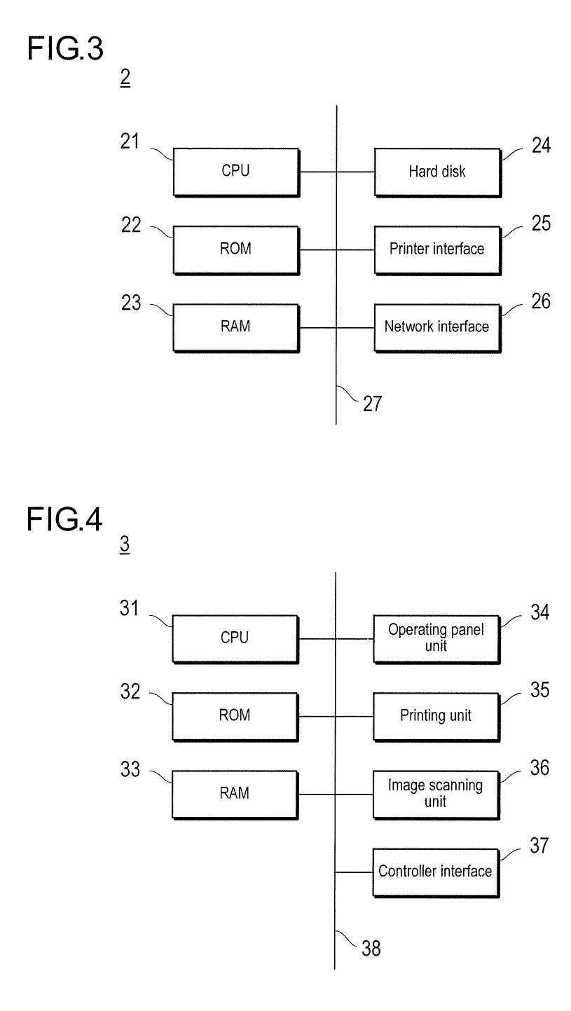

FIG. 3 is a block diagram showing the constitution of the printer controller 2 of the printer system 4 shown in FIG. 1.

The printer controller 2 is provided with a CPU 21, a ROM 22, a RAM 23, a hard disk 24, a printer interface 25, and a network interface 26, all of which are interconnected with each other via a bus 27 for exchanging signals. The descriptions of those parts of the printer controller 2 that have the same functions as those of the corresponding parts of the PC 1 will be omitted here to avoid being duplicative.

Stored on the ROM 22 or the hard disk 24 are: a rasterization process program for translating the PDL data received from the PC 1 and developing it into image data of the bit map format; a gradation correction process program for applying a gradation correction process to the image data of the bitmap format; and a halftone processing program for applying the halftone process to the image data to which the gradation correction process is applied.

The gradation correction process is a process of adjusting the density of the image using a tone curve that represents the output density corresponding to the input density. The halftone process is a process of expressing gradation by means of adjusting the size of the dots. The density of halftone dots is expressed, for example, by the number of lines per inch (lpi). There are several kinds of halftone dots.

Throughout this description of the present invention, the term “density” includes the concept of lightness as well.

The printer interface 25 is an interface for communicating with the locally connected printer 3.

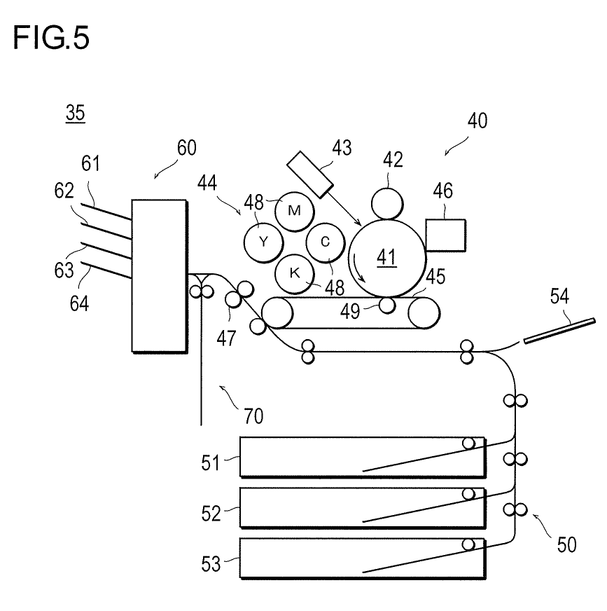

FIG. 4 is a block diagram showing the constitution of the printer 3 of the printing system 4 shown in FIG. 1. The printer 3 has a CPU 31, a ROM 32, a RAM 33, an operating panel 34, a printing unit 35, an image scanning unit 36, and a controller interface 37, all of which are interconnected with each other via a bus 38 for exchanging signals. The descriptions of those parts of the printer 3 that have the same functions as those of the corresponding parts of the PC 1 will be omitted here to avoid being duplicative.

The ROM 32 stores a printing process program to be executed based on printing data received from the printer controller 2.

The operating panel unit 34 is equipped with a touch panel, a ten-keypad, a start button, a stop button and others to be used for displaying various data and entering various instructions.

The printing unit 35 prints images based on printing data received from the printer controller 2 using a publicly known image process such as the electronic photography process on recording media such as paper.

Image scanning unit 36 obtains image data by scanning documents. More specifically, the document scanning unit 36 illuminates the document with fluorescent lamp and others, converts from reflecting light to electrical signals by means of light receiving devices such as CCD image sensors, and creates image data from the electrical signals.

The controller interface 37 is an interface for communicating with the locally connected printer controller 2.

FIG. 5 is a diagram showing the typical constitution of a printing unit 35.

The printing unit 35 has a paper supply unit 50 for supplying recording media such as printing paper, an image forming unit 40 for forming images on the recording media, and a paper discharge unit 60 for discharging printing paper. The printing unit 35 also has a reversing mechanism unit 70 for reversing the front and back sides of the recording media such as printing paper.

The image forming unit 40 of the printing unit 35 has a sensitizer drum 41 that rotates in the arrow direction, a charging device 42, an exposing device 43, a developing device 44, an intermediate transfer belt 45, a cleaning device 46, and a fixing device 47. After the surface of the sensitizer drum 41 is evenly charged by means of the charging device 42, an electrostatic latent image is formed on the surface of the sensitizer drum 41 as it is irradiated with laser beams by the exposing device 43. The electrostatic latent image becomes an apparent image as the toner adheres to the electrostatic latent image on the sensitizer drum 41 as the sensitizer drum 41 turns. The developing device 44 has a developing controller 48 for each of the colors, cyan (C), magenta (M), yellow (Y), and black (K) respectively, and developed toner images of these colors are transported to the transfer unit 49, then onto the intermediate transfer belt 45 one after the other, and overlaid on top of each other there, so that the overlaid color image can be transferred to the printing paper supplied from the paper supply unit 50. The toner images are then fixed on the printing paper by the fixing device 47 and transported to the paper discharge unit 60.

The paper supply unit 50 has a plurality of sheet supply trays 51-54. The sheet supply tray 54 is a manual feed sheet supply tray. The paper discharge unit 60 is equipped with a plurality of paper discharge trays 61-64. The paper discharge unit 60 may have a post-processing part for providing post-processes such as punching or stapling to the printing paper transported there.

The PC 1, the printer controller 2, and the printer 3 can each contain constitutional elements other than those described above, or may lack a portion of the abovementioned elements.

The operation of the network system in this embodiment will be described in the following.

In the normal printing mode, the PC 1 converts the document file created by the document creating application program into PDL data by the printer driver and transmits it to the printing system 4. The printer controller 2 of the printing system 4 converts the received PDL data by the rasterizing process into bitmap type image data, prepare printing data by applying the gradation correction process and the halftone process, and outputs the created data to the printer 3. The printer 3 prints the image indicated by the received printing data.

The PC 1 has a function of performing settings concerning the gradation correction process conducted by the printer controller. 2. At this time, the PC 1 can correct the tone curve to be used in the gradation correction process, and instruct the confirmation printing of the image data, which is processed with the gradation modification using the corrected tone curve. A case of executing such a confirmation printing mode is described in the following.

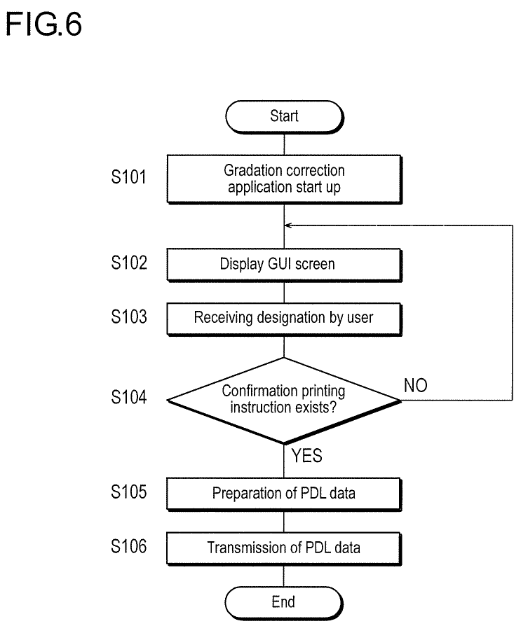

FIG. 6 is a flow chart showing the process procedure on the PC 1. The algorithm shown in the flowchart of FIG. 6 is stored as a program in a storage unit such as a hard disk 14 of the PC 1 and executed by the CPU 11.

In case of setting up for the gradation correction process, the gradation correction application program is initiated based on the user's operation (S101).

Next, the Graphical User Interface (GUI) screen for setting up for the gradation correction process is displayed on the display 15 by the gradation correction application program (S102).

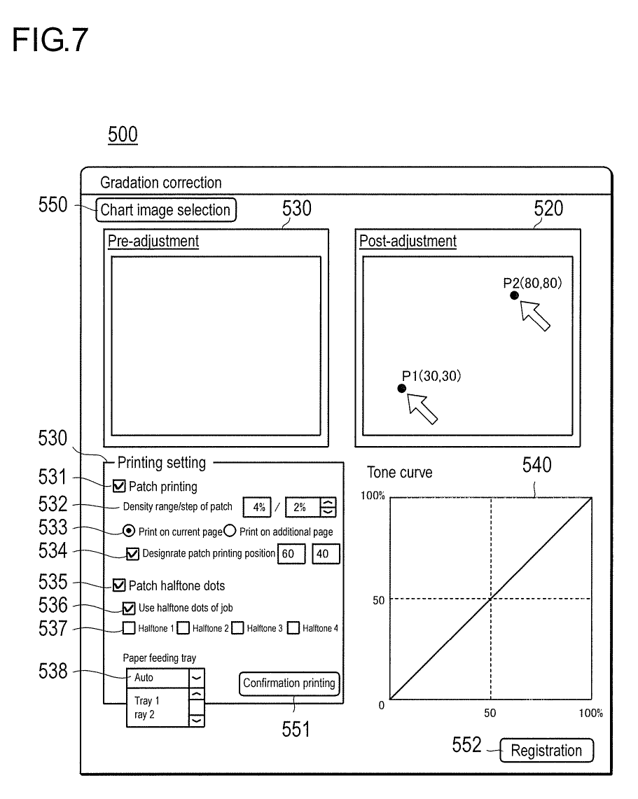

FIG. 7 is a diagram showing an example of a GUI screen 500.

The GUI screen 500 has a tone curve area 540 for displaying and correcting a tone curve to be used in the gradation correction process, an image selection button 550 for selecting a chart image to be used for the tone curve, a pre-adjustment chart image display area 510, a post-adjustment chart image display area 520 for displaying the chart image after the gradation correction process using the tone curve is applied, a confirmation printing setting part 530 for setting up for the confirmation printing of the chart image applied with the gradation correction process using the tone curve, and a registration button 552 for registering the corrected tone curve to be used by the printer controller 2.

In this embodiment, the user can designate an arbitrary position within the chart image displayed in the post-adjustment chart image display area 520, for example, by clicking, as a focal position for correcting the density. In FIG. 7, the two points “P1” and “P2” are designated by the user. Also, once a focal position is designated by the user, the coordinate of the designated position is obtained. In FIG. 7, the coordinates in the X-Y coordinate system having an origin at the left bottom of the image data are displayed (same in the following).

The confirmation printing setting part 530 includes a checkbox 531 for the user to designate whether or not a patch image that provides patches of a plurality of candidates for the output density after the density adjustments are made using the tone curve at the focal points designated by the user within the chart image. If the checkmark is not entered into the checkbox 531, only the chart image is confirmation printed. The confirmation printing setting part 530 contains a parch density range/step designating part 532 for allowing the user to designate the density range for all the patches and the density interval between the patches designated by the user using the output density based on said image data at said focal positions as the standard, a radio button 533 for allowing the user to designate whether or not to print the patch image on the same page as the chart image or on a different page, and a patch printing position designating part 534 for allowing the user to designate the position to print the patch image within the page.

Furthermore, the confirmation printing setting part 530 contains a checkbox 535 for allowing the user to designate whether or not to set up the halftone dots to be used in printing the patch image. If the checkmark is not entered into the checkbox 535, the default halftone is used. The confirmation printing setting part 530 also contains a checkbox 536 for allowing the user to designate the use of the printing job's halftone dots, and a checkbox 537 for allowing the user to designate the use of the halftone dots prepared in advance. If a plurality of checkboxes 536 and 537 is designated, a multiple kinds of patch images are printed. By designating the halftone, the user can select more precisely the patches of the desired densities.

The confirmation printing setting part 530 also contains a pull-down menu 538 for allowing the user to designate the paper feed tray to be used in the confirmation printing and a confirmation printing button 551 for instructing the confirmation printing of the chart image.

The tone curve displayed in the tone curve area 540 allows the user to correct it by dragging a point on the tone curve. On the tone curve shown in FIG. 7, the horizontal axis shows the input density while the vertical axis shows the output density.

The chart image selected by the chart image selection button 550 can be a predetermined one created in advance, or one that is created by the user arbitrarily.

Going back to the flowchart of FIG. 6, the user's designation is received on the GUI screen 500 in step S103.

In step S104, a decision is made whether the confirmation printing instruction is made or not, in other words, whether the confirmation printing button 551 is depressed or not. If the confirmation printing button 551 is not depressed (S104: No), the program returns to step S102.

If the confirmation printing button 551 is depressed (S104: Yes), PDL data, i.e., the printing job for confirming the chart image, is created (S105).

Various kinds of information obtained in the step S103 are described in the PDL data as command data.

For example, in case of the setting shown in the GUI screen 500 shown in FIG. 7, the setting information as shown below is described in the PDL data:

Focal position information: P1 (30, 30), P2 (80,80)

Patch image printing position: (60, 40)

Patch density width W (density range of all patches): −4% to +4%

Patch step S (density interval between patches): 2%

Halftone dots: halftone dots of the job (halftone dots used for the job)

Paper feed tray: tray 1

The tone curve data is also described in the PDL data.

Next, in step S106, the PDL data thus created is transmitted to the printer controller 2 of the printing system 4 via the network 5.

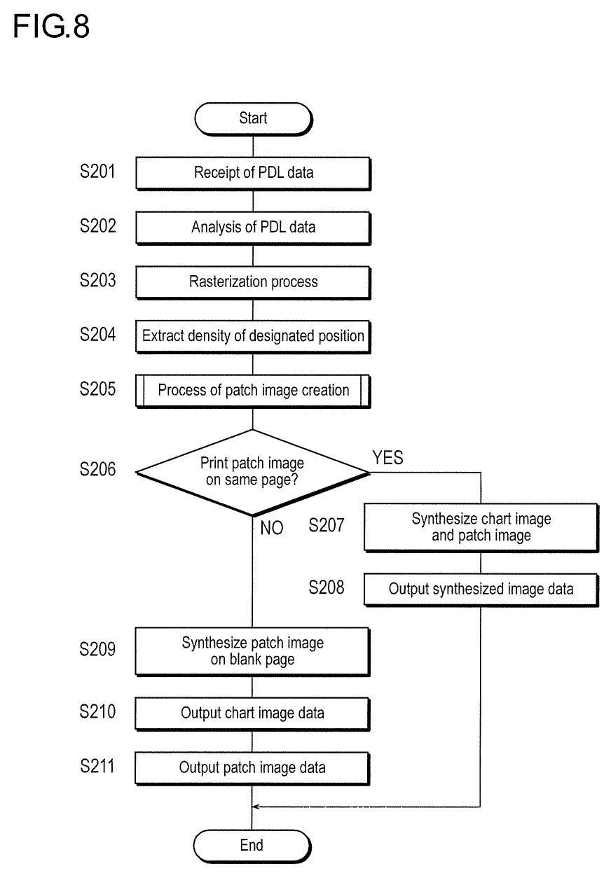

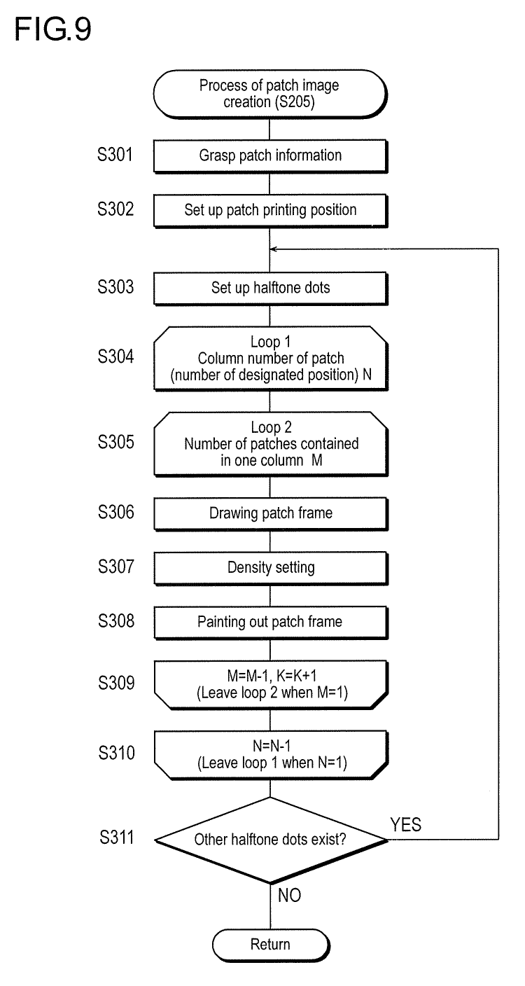

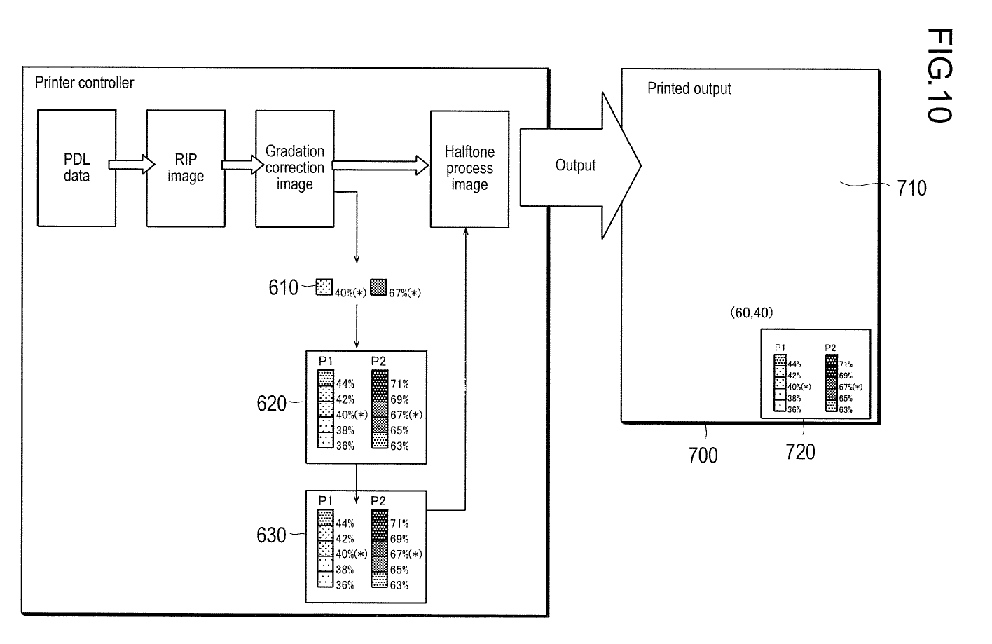

Next, the image recording process in the printer controller 2 will be described below referring to FIG. 8 and FIG. 9. The algorithm shown in the flowchart of FIG. 8 and FIG. 9 is stored as a program in a storage unit such as a hard disk 24 of the printer controller 2 and executed by the CPU 21.

FIG. 10 is a schematic diagram for describing the creation and output of the patch image. FIG. 10 corresponds to the setting shown in the GUI screen 500 shown in FIG. 7. The process of creating a patch image is described below.

First, the printer controller 2 receives the PDL data from the PC 1 (step S201), and analyzes the PDL data (S202). The setting information described in the PDL data is stored in a memory unit such as the RAM 23.

The chart image in the received PDL data is rasterized to be converted into image data of the bitmap format (S203). The chart image after the rasterization process is stored in a memory unit such as RAM 23 after the gradation correction process is applied using the tone curve.

Next, the density of the focal position designated by the user in the chart image stored in a memory unit such as RAM 23 (S204). The focal position can be grasped from the setting information obtained in step S202. The reference number “610” in FIG. 10 schematically indicates a patch with the densities of the focal positions designated by the user.

The printer controller 2 then creates a patch image having a plurality of candidates of output densities at the focal positions of the chart image after the density adjustment by means of the tone curve (S205).

FIG. 9 is a flow chart showing the sequence of creating a patch image.

In the patch image creation process, the patch information is first grasped from the setting information obtained in step S202 (S301).

Next, the printing position of the patch information within the page is set up based on the grasped patch information (S302).

Moreover, based on the patch information grasped as described above, a halftone dot is set up (S303).

In step S304, a loop 1 is initiated and a column number N for the patch is set up. The column number N of the patch is identical to the number of the focal positions designated by the user in the chart image. For example, N=2 in FIG. 10.

In step S305, the loop 2 is initiated and the number of patches M contained in a single column is specified. The number of patches M contained in a single column is calculated as M=((the integer value of (patch density width W/patch step S))*2+1. For example, in FIG. 10, M=(the integer value of (4/2))*2+1=5.

In step S306, a single patch frame is drawn.

Next, the density of a single patch is set up (S307). The density D of a single patch is calculated as D=(output density at the focal position designated by the user−patch density width W)+patch step S×K (initial value=0). The patch density of a patch column is set up sequentially from the patch with a lower density to the patch with a higher density.

Next, the patch frame drawn in step S306 is painted out with a density set up in step S307 (S308).

In step S309, M is decremented by 1 (M=M−1), and K is incremented by 1 (K=K+1). When it reaches the state of M=1, one patch column is completed and the program leaves the loop 2.

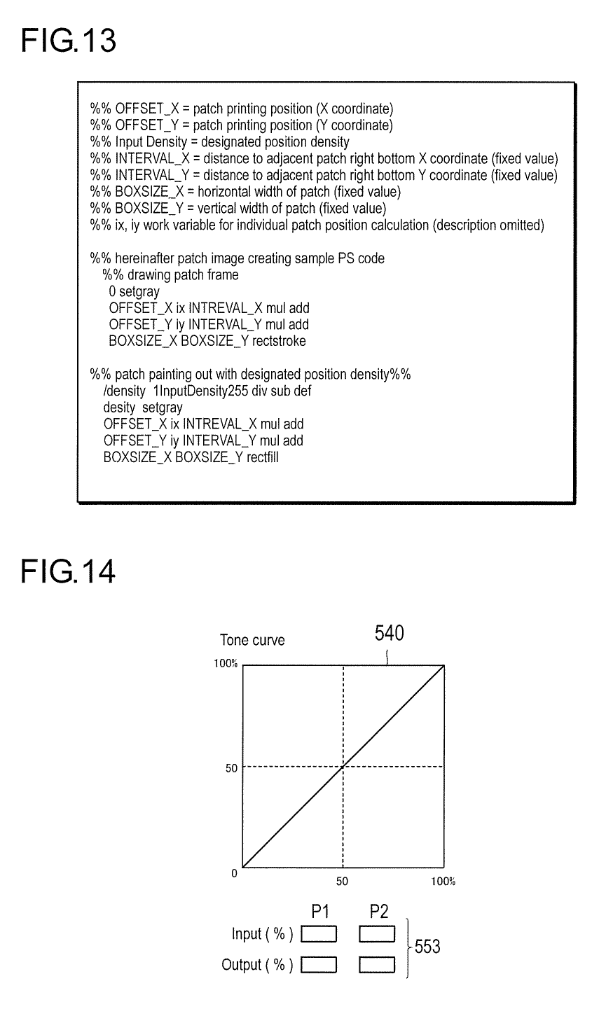

The patch image creation is executed, for example, by repeating the codes shown in FIG. 13, as many times as the number M of the patches. The “InputDensity” shown in FIG. 13 is the density set up in step S307.

In step S310, N is decremented by 1 (N=N−1). When it reaches the state of N=1, as many patch columns as the number of the focal positions are created to complete the patch image 620 (see FIG. 10) prior to the halftone process. Furthermore, when the patch image 630 applied with the halftone process (see FIG. 10) is created, the program leaves the loop 1.

It is preferable if the patch images 620 and 630 contain information that indicate the density values of the patches as shown in FIG. 10, so that the user can verify the density values of the patches precisely by numerical values when they are printed out.

In step S311, a judgment is made on whether any other halftone designations exist or not based on the grasped patch information.

If there are any other halftone designations exist (S311: Yes), the program returns to step S303 and steps S303 through S310 are repeated. If there is no other halftone designation (S311: No), the program returns to the flowchart of FIG. 8.

In step S206 shown in FIG. 8, a judgment is made on whether or not a designation exists for printing the patch image and the chart image on a same page. Such a judgment is made based on the setting information obtained in step S202.

If it is judged that a designation exists for printing the patch image and the chart image on a same page (S206: Yes), the chart image and the patch image are synthesized and synthesized image data is created (S207). The synthesized data is then outputted to the printer 3 as printing data (S208). The printer 3 prints the image indicated by the received synthesized image data on a printing medium such as printing paper. As shown in FIG. 10, the printed output 700 obtained on the printer 3 contains a chart image 710 and a patch image 720. If a patch image and a chart image are printed on a same page, the user has the benefit of identifying visually with ease both the focal position whose density needs to be corrected and the patch. Also, since it is possible to set up the printing position of the patch image and the focal position in such a way that they do not overlap with each other, it is possible to prevent the focal position from being hidden by the patch image.

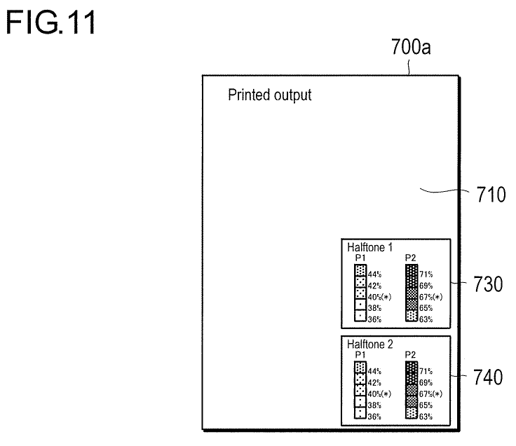

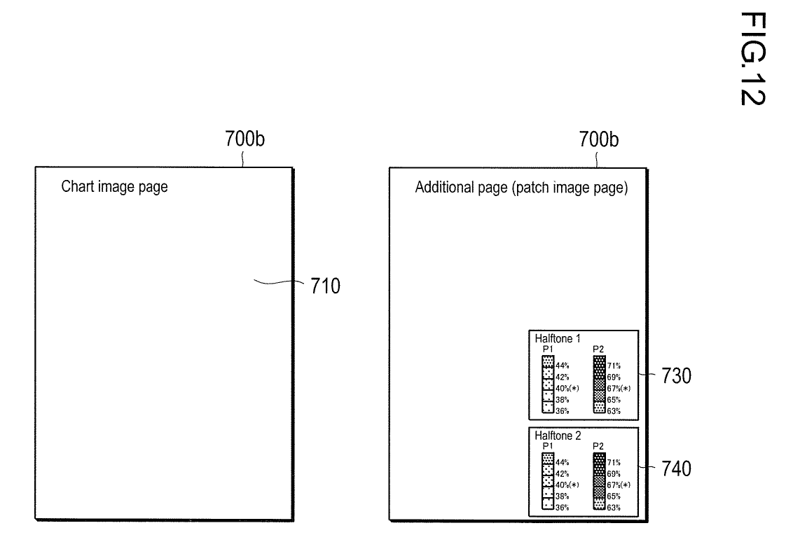

In case several kinds of half tones are used, a printed output 700a contains several kinds of patch images 730 and 740 as shown in FIG. 11.

On the other hand, if it is judged that a designation exists for printing the patch image and the chart image on separate pages (S206: No), the patch image is synthesized on a blank page with no information to be printed to create the patch image data and store it in a memory unit such as RAM 23 (S209). The chart image data is then outputted to the printer 3 as printing data (S210). Next, the patch image data is then outputted to the printer 3 as printing data (S211). Moreover, the printer 3 prints the image indicated by the received chart image data on a separate sheet of printing paper. The printer 3 prints the image indicated by the received patch image data on printing paper. In this case, a printed output 700b consists of a page that contains the chart image 710 and a page that contains the patch images 730 and 740 as shown in FIG. 12 If the patch image and the chart image are printed on separate pages, it is beneficial for the user as the entire chart image and the patch image can be reviewed visually at the same time.

It is possible for the user to select the desired output densities for the focal positions designated by the user from a plurality of patches contained in the patch images of the printed outputs 700, 700a, and 700b. Thus, it is possible for the user to estimate quickly and easily the desired output densities corresponding to the printer's characteristics at the focal positions without having to repeat the confirmation printing. Therefore, it becomes possible to correct the tone curve easily to match with the user' request by reflecting the desired output densities at the focal positions on the tone curve.

For example, a correction can be accomplished as the user drags a point on the tone curve displayed in the tone curve area 540 of the GUI screen 500 shown in FIG. 7. For example, in this case, the input density (horizontal axis) of the correction point is fixed on the density of the focal position of the chart image, and only the output density (vertical axis) changes while indicating the density value as the correction point is dragged. Alternatively, input boxes 553 for reflecting the input densities and the output densities of the focal positions (“P1” and “P2” in FIG. 14) on the tone curve can be displayed on the GUI screen 500 as shown in FIG. 14. In this case, the input densities and the output densities before the correction are displayed initially in the input boxes 553. The user selects the desired output densities for the focal positions from the plurality of patches contained in the patch images of the printed outputs 700, 700a and 700b and enters them in numerical values in the output density cells of the input boxes 553.

As can be seen from the above, in the first embodiment, the focal positions designated by the user in the chart image are recognized to create a parch image having the patches that indicate a plurality of output density candidates after the density adjustment by means of the tone curve at the particular focal points. The chart image and the patch image are then outputted.

Therefore, the user can select the desired output densities at the focal positions from a plurality of patches, so that the user can quickly and easily estimate the desired densities at the focal positions without having to repeat confirmation printing. Hence, it becomes possible to correct the tone curve easily to match with the user's request by reflecting the desired output densities at the focal positions on the tone curve.

Furthermore, although the information concerning the focal positions in the chart image is displayed by the dots that indicate the positions, characters such as “P1,” coordinates, and arrows within the chart image shown in the chart image display area 520 after the adjustment shown in FIG. 7 in the first embodiment, it can also be indicated only by one of them. Moreover, it is desirable from the viewpoint of further facilitation of the user's reference that the information indicating the focal positions within the chart image is printed out in arrows and the like in the chart image 710 of the printed outputs 700, 700a and 700b.

Although a case in which both the chart image and the patch image are outputted to print in the first embodiment, the present invention is not limited to it. The present invention is applicable to a case in which both the chart image and the patch image are outputted to display on a screen.

Moreover, in the first embodiment, the user designates an arbitrary position within the chart image displayed in the post-adjustment chart image display area 520, as a focal position for correcting the density. This is to correspond to the creation of the patch image using the output density after the density adjustment by means of the tone curve as the standard. However, it is possible to designate an arbitrary position within the chart image displayed in the pre-adjustment chart image display area 510 as the focal position for the density correction, including a case where the pre-adjustment chart image coincides with the post-adjustment chart image, if we limit ourselves to use it for the purpose of the designation of the focal position.

Next, the second embodiment of the invention will be described below. Since the hardware constitution is identical to that of the first embodiment, the description is omitted. The following description according to the second embodiment therefore focuses on those points which are different from the first embodiment.

The second embodiment provides a method of easily correcting the tone curve using the outputted chart image and patch image, by outputting the chart image, and the patch image having patches that indicate a plurality of candidates of the output densities after the density adjustment using the tone curve in correspondence with the particular chart image.

The procedure concerning the confirmation printing instruction in the PC 1 in the second embodiment is as shown in the flowchart of FIG. 6 similar to the first embodiment.

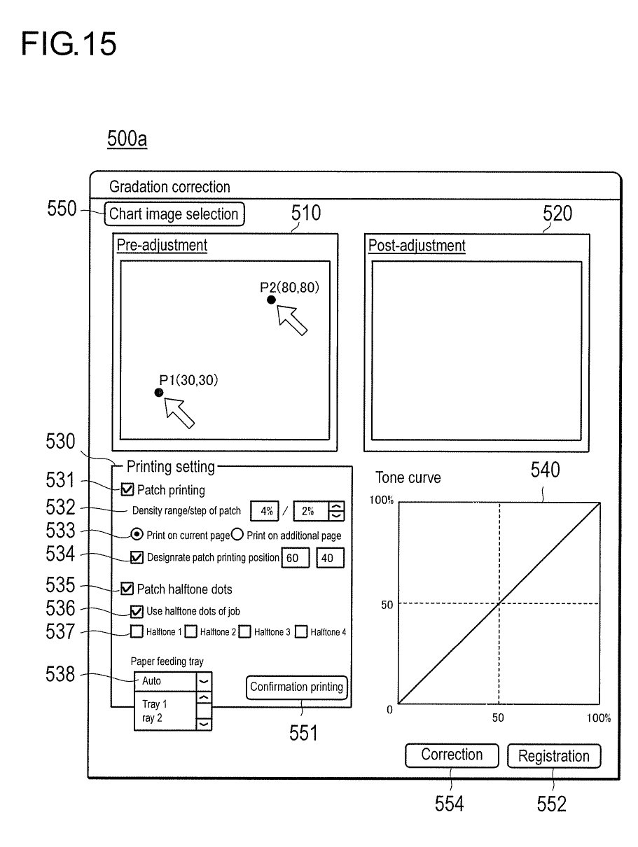

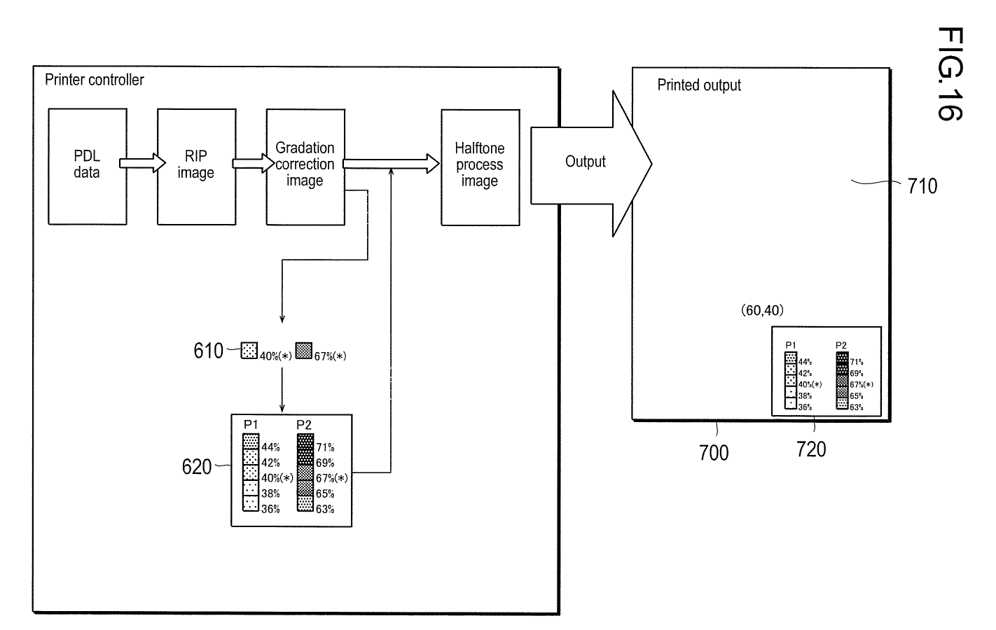

FIG. 15 is an example of the GUI screen 500a concerning the second embodiment.

In the second embodiment, the user can designate an arbitrary position within the chart image displayed in the pre-adjustment chart image display area 510, for example, by clicking, as a focal position for correcting the density. In FIG. 15, the two points “P1” and “P2” are designated by the user. The tone curve used for the confirmation printing here is a straight line with an inclination 1.

The GUI screen 500a has a correction pushbutton 554 in addition to various parts shown on the GUI screen 500 shown in FIG. 7. When the correction button 554 is depressed, the chart image and the patch image are selected and displayed on the pre-adjustment chart image display area 510 and can be used for the correction of the tone curve.

The procedure in the printer controller 2 in the second embodiment is as shown in the flowchart of FIG. 8 and FIG. 9 similar to the first embodiment. While the synthesized image data is created by synthesizing the chart image after the halftone process and the patch image after the halftone process in the first embodiment, the synthesized image data is created by applying the halftone process after the synthesis of the chart image and the patch image in the second embodiment. However, the application of the halftone process can be either before or after the synthesis of the chart image and the patch image. Moreover, the chart image and the patch image can be created on separate pages.

FIG. 16 is a schematic diagram for describing the creation and output of the patch image concerning the second embodiment. The density adjustment by means of the tone curve, i.e., the gradation correction process, is not executed here.

The printer 3 prints the image indicated by the received synthesized image data on a printing medium such as paper. As shown in FIG. 16, the printed output 700 obtained on the printer 3 contains the chart image 710 and the patch image 720 (same as in FIG. 10). Moreover, the chart image and the patch image can be created on separate pages, and the printed outputs consist of several pages in such a case (refer ti FIG. 12).

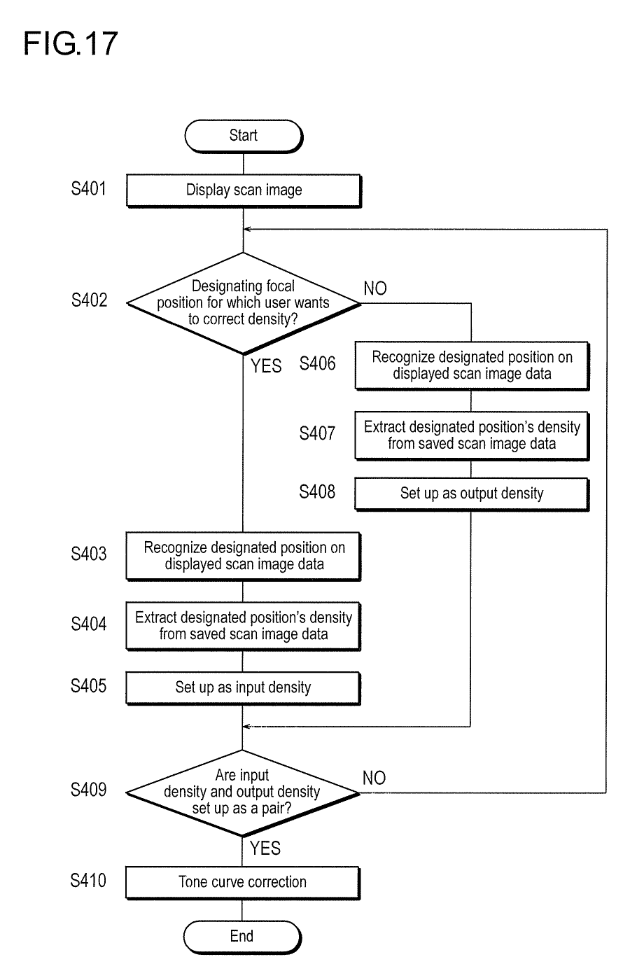

FIG. 17 is a flowchart showing the process of tone curve correction on the PC 1 according to the second embodiment. The algorithm shown in the flowchart of FIG. 17 is stored as a program in a storage unit such as a hard disk 14 of the PC 1 and executed by the CPU 11.

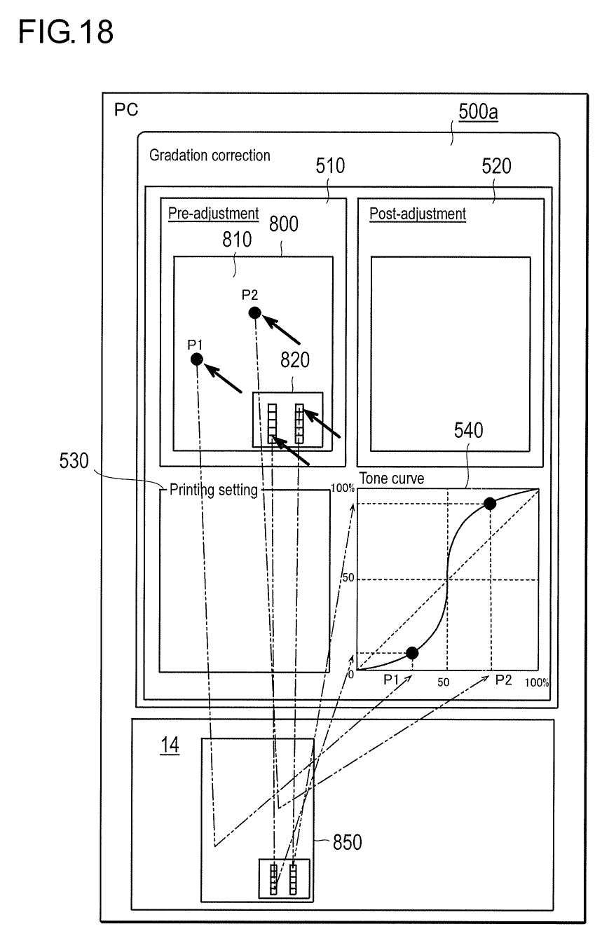

As a premise, the scan image data is obtained by scanning the printed outputs 700 shown in FIG. 16 by the image scanning unit 36 of the printer 3. A scan image data 850 thus obtained is stored on the hard disk 14 of the PC 1 as shown in FIG. 18.

When the correction button 554 of the GUI screen 500a is depressed and the scan image data 850 stored on the hard disk 14 is designated, the scan image data 800 as a display image is displayed on the pre-adjustment chart image display area 510 as shown in FIG. 18 (S401).

FIG. 18 is a diagram for describing the method of correcting a tone curve using the chart image and the patch image which are displayed. As shown in the diagram, the scan image data 800 contains the chart image 810 and the patch image 820.

Next, the designation of the focal position for which the user wants to correct the density or the designation of the patch position of the output density the user wants are accepted on the scan image data 800 currently displayed. Then a judgment is made as to whether any focal position for which the user wants to correct the density is designated or not (S402). Left-click of the mouse while it is on the scan image data 800 can be judged as a designation of the focal position, and “Ctrl”+left-click of the mouse while it is on the scan image data 800 can be judged as a designation of the patch position. However, the method of identifying whether the focal position or the patch position is designated is not limited to the method described above. For example, it is possible to judge whether the focal position or the patch position is designated based on whether the mouse clicking occurs in the area of the chart image 810 or in the area of the patch image 820 on the scan image data 800. It is also possible for the user to identify a position by a certain mark such as a framing mark on the printed output 700. In such a case, the system can accept the position designation and identify the designated position by scanning the marked-up printed output 700 and analyzing the scan image data.

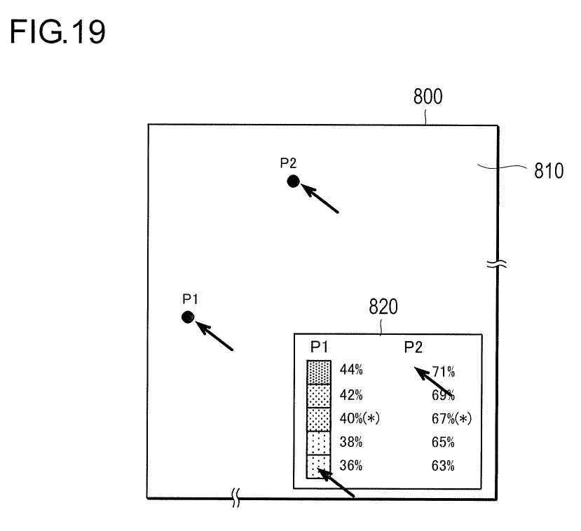

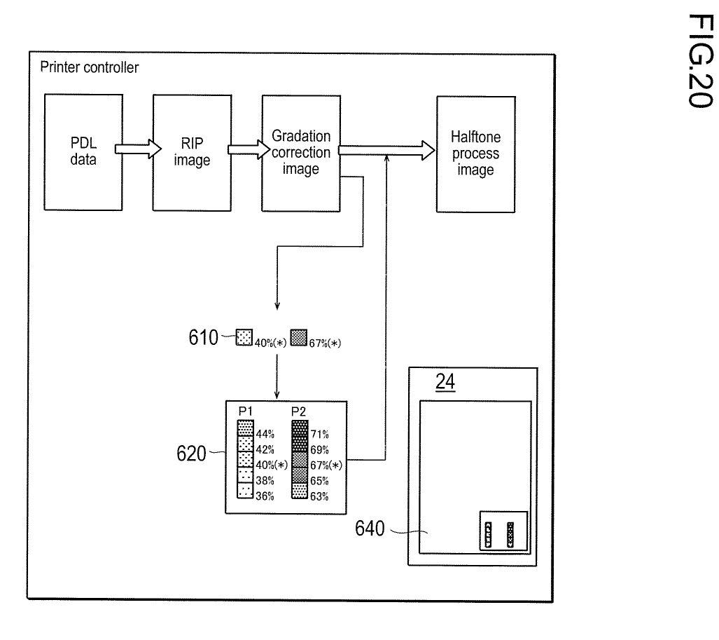

FIG. 19 is an enlarged diagram of the scan image data 800 for describing the process of designating the focal position and the patch position

When it is judged that the designation of the focal position for which the user wants to correct the density is accepted (S402: Yes), the designated position is recognized on the displayed scan image data 800 (S403). Next, the density is extracted for the position that corresponds to the designated position recognized in step S403 in the scan image data 850 stored in the hard disk 14 (S404). The extracted density is then set up as the input density (S405).

On the other hand, when it is judged that the designation of the patch position with the output density desired by the user is accepted (S402: No), the designated position is recognized on the displayed scan image data 800 (S406). Next, the density is extracted for the position that corresponds to the designated position recognized in step S406 in the scan image data 850 stored in the hard disk 14 (S407). The extracted density is then set up as the output density (S408).

A judgment is made as to whether or not the input density and the output density are set up as a pair in step S409.

If it is judged that the input density and the output density are set up as a pair (S409: Yes), the tone curve is corrected based on the input density set up in the step S405 and the output density set up in step S408 (S410). More specifically, the tone curve is corrected using the Bezier curve in such a way as to output the output density set up in step S408 when the input density set up in step S405 is entered.

Furthermore, the process shown in the flowchart of FIG. 17 is repeated when other focal positions or patch positions are designated. FIG. 18 and FIG. 19 show the case where the two focal positions “P1” and “P2” are designated by the user. In this case, the tone curve is corrected in such a way that the input density of the focal point “P1“is adjusted to the output density 36%, and the input density of the focal point “P2” is adjusted to the output density 71%.

As can be seen from the above, in the second embodiment, the system outputs a chart image and a patch image equipped with patches indicating a plurality of candidates of the output density after the density adjustment using the tone curve concerning the particular chart image. The system also obtains the density of the focal position designated by the user in the outputted chart image, and the density of the patch designated by the user in the outputted patch image. The tone curve is corrected in such a way that the patch density obtained is outputted when the density of the focal position obtained is entered.

Therefore, the user can easily and accurately designate the position in the chart image for which the user wants to correct the density and the output density after the correction. This makes it possible to correct the tone curve easily by accurately reflecting the user's request.

Moreover, in the second embodiment, since the chart image and the patch image are printed out, the user can designate the position in the chart image for which the user wants to correct the density and the patch of the desired output density using the scan image data obtained by scanning the particular printed output while actually watching said printed output. Thus, the user's request is more precisely reflected.

Next, the third embodiment of the invention will be described below. Since the hardware constitution is identical to that of the second embodiment, the description is omitted. The following description according to the third embodiment therefore focuses on those points which are different from the second embodiment.

FIG. 20 is a schematic diagram for describing the creation of the patch image concerning a third embodiment. In the second embodiment, the scan image data 850 is obtained as a result of printed output 700 containing the chart image and the patch image being scanned by the image scanning unit 36 of the printer 3. On the other hand, in the third embodiment, synthesized image data 640 containing the chart image and the patch image is stored in a storage unit such as the hard disk 24. In the third embodiment, the synthesized image data 640 before the halftone process is stored. As described later, since the density of the focal position is extracted from the synthesized image data 640, there is no need for the halftone process. In the third embodiment, the printing output to the printer 3 is not done in creating a patch image.

The procedure of the process concerning the tone curve correction in the PC 1 in the third embodiment is as shown in the flowchart of FIG. 17 similar to the second embodiment. However, as a premise, the synthesized image data 640 is saved in the hard disk 14 of the PC 1 in place of the scan image data 850. Based on the operation of the PC 1, the synthesized data 640 can be obtained by the PC 1 from the printer controller 2 to be saved in the PC 1, or the synthesized image data 640 can be transmitted from the printer controller 2 to the PC 1, which is the transmission source of the chart image, to cause the PC 1 to save the synthesized 640 it received.

In step S401, when the correction button 554 of the GUI screen 500a (refer to FIG. 15) is depressed and the synthesized image data 640 saved in the hard disk 14 is designated, the synthesized data as a displayed image is displayed in the pre-adjustment chart image display area 510. The rest of the procedure is the same as in the second embodiment except the fact that the synthesized image data is used instead of the scan image data.

According to the third embodiment, as can be seen from the above, it is possible to achieve the same effect as in the second embodiment in a simple method without printing out the chart image and the patch image.

It is obvious that this invention is not limited to the particular embodiments shown and described above but may be variously changed and modified without departing from the technical concept of this invention.

For example, although it was described assuming a case of density adjustment of monochromatic (gray scale) image data in the above embodiment, the invention is not limited to it and is applicable to a case of color image data. In case of color image data, it is possible to adjust the entire density using a tone curve for adjusting all color components. As to the color coordinate system, it is applicable to the CMYK mode, the RGB mode, etc.

Furthermore, although it is describe in the above embodiment a constitution wherein the printing system 4 is divided into the printer controller 2 and the printer 3, both of which are locally connected, the printer controller 2 can be built into the printer 3.

Also, although the embodiments described above uses a printer as the image forming apparatus, the invention is not limited to it. The present invention is applicable to an image forming apparatus such as MFP (Multi-Function Peripheral) and a copying machine as well.

Also, although the embodiments described above assumed a case where the gradation correction application program that sets up the gradation correction process conducted in the printer controller 2 is installed in the PC 1, the entire network system that contains the PC 1 and the printing system 4 functions as the image processing apparatus. The present invention is also applicable to a case where the gradation correction application program is installed in the MFP and the GUI screen for setting up the gradation correction process is displayed on the operating panel of the MFP, and the MFP in itself can function as an image processing apparatus in such a case.

The means and method of conducting various processes in the network system according to the present invention can be realized by means of a dedicated hardware circuit, or a programmed computer. Said program can be provided either by a computer readable recording medium such as a flexible disk and a CD-ROM, or by being supplied on-line via a network such as the Internet. In this case, the program recorded on the computer readable recording medium is ordinarily transferred to and stored in a storage unit such as a hard disk. Said program can also be provided as independent application software or can be built into the software of the apparatus as a part of its function.

What is claimed is:

1. An image processing apparatus, comprising:
a display unit for displaying an image based on image data;
an identifying unit for identifying a focal position designated by a user within said image displayed on said display unit;
a creating unit for creating patch image data equipped with patches indicating a plurality of candidates of output density after density adjustment using a tone curve based on said image data at said focal position; and
an outputting unit for outputting said image data and said patch image data.

2. The image processing apparatus as claimed in claim 1, wherein
said outputting part further outputs information that indicates said focal position within said image.

3. The image processing apparatus as claimed in claim 1, wherein
said creating unit creates patch image data in accordance with the density range of all the patches and the density interval between the patches designated by the user, using the output density based on said image data at said focal position as the standard.

4. The image processing apparatus as claimed in claim 1, wherein
said patch image data contains information that indicates the density value of each patch.

5. The image processing apparatus as claimed in claim 1, wherein
said outputting unit outputs said patch image data to an identical page to which said image data belongs.

6. The image processing apparatus as claimed in claim 5, wherein
said patch image data is outputted to a location within the page which is designated by the user.

7. The image processing apparatus as claimed in claim 1, wherein
said outputting unit outputs said image data and said patch image data for printing with the halftone dots designated by the user.

8. An image processing method, comprising:
1) displaying an image based on image data;
2) identifying a focal position designated by a user within said image displayed in the step 1);
3) creating patch image data equipped with patches indicating a plurality of candidates of output density after density adjustment using a tone curve based on said image data at said focal position; and
4) outputting said image data and said patch image data.

9. A computer readable recording medium stored with an image processing program, said image processing program causing a computer to execute a process comprising:
1) displaying an image based on image data;
2) identifying a focal position designated by a user within said image displayed in the step 1);
3) creating patch image data equipped with patches indicating a plurality of candidates of output density after density adjustment using a tone curve based on said image data at said focal position; and
4) outputting said image data and said patch image data.

10. An image processing apparatus, comprising:
a displaying unit for displaying an image based on image data, and a patch image based on patch image data equipped with patches indicating a plurality of candidates of output density after density adjustment using a tone curve for said image data;
a first density obtaining unit for obtaining based on said image data the density of a focal position designated by a user within said image displayed by said displaying unit;
a second density obtaining unit for obtaining based on said patch image data the density of a patch designated by the user within said patch image displayed by said displaying unit; and
a correcting unit for correcting said tone curve in such a way as to output the density obtained by said second density obtaining unit when the density obtained by said first density obtaining unit is entered.

11. The image processing apparatus as claimed in claim 10, further comprising:
a printing unit for printing an image based on said image data, and a patch image based on said patch image data; and
an image scanning unit for scanning said image and patch image printed by said printing unit, wherein
said display unit displays said image based on said image data and said patch image based on data obtained by said image scanning unit.

12. The image processing apparatus as claimed in claim 10, wherein
said patch image data is equipped with patches that indicates a plurality of candidates of output density after density adjustment by said tone curve based on said image data at said focal position designated by the user within said image displayed on said display unit.

13. The image processing apparatus as claimed in claim 12, wherein
said patch image data is equipped with a plurality of patches created in accordance with the density range of all patches designated by the user and the density interval between the patches, using as the standard the output density based on said image data at said focal position.

14. The image processing apparatus as claimed in claim 11, wherein
said printing unit prints said patch image based on said patch image data to an identical page to which said image data based on said image data belongs.

15. The image processing apparatus as claimed in claim 14, wherein
said patch image data based on said patch image data is printed to a location designated by the user within the page.

16. An image processing method, comprising:
1) displaying an image based on image data, and a patch image based on patch image data equipped with patches indicating a plurality of candidates of output density after density adjustment using a tone curve for said image data;
2) obtaining based on said image data the density of a focal position designated by a user within said image displayed in the step 1);
3) obtaining based on said patch image data the density of a patch designated by the user within said patch image displayed in the step 1); and
4) correcting said tone curve in such a way as to output the density obtained in the step 3) when the density obtained in the step 2) is entered.

17. A computer readable recording medium stored with an image processing program, said image processing program causing a computer to execute a process comprising:
1) displaying an image based on image data, and a patch image based on patch image data equipped with patches indicating a plurality of candidates of output density after density adjustment using a tone curve for said image data;
2) obtaining based on said image data the density of a focal position designated by a user within said image displayed in the step 1);
3) obtaining based on said patch image data the density of a patch designated by the user within said patch image displayed in the step 1); and
4) correcting said tone curve in such a way as to output the density obtained in the step 3) when the density obtained in the step 2) is entered.
